(19) United States
(12) Patent Application Publication
(10) Pub. No.: US 2004/0122568 A1
(43) Pub. Date: Jun. 24, 2004

(54) System for controlling the attitude of a geostationary satellite

(75) Inventors: Eric Montfort, Mandelieu (FR); Cedric Salenc, Cannes La-Bocca (FR); Xavier Roser, Cannes (FR); Loic Gaudic, Cannes (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/687,585

(22) Filed: Oct. 20, 2003

(30) Foreign Application Priority Data
Oct. 21, 2002 (FR) 02 13 052

(51) Int. Cl. G05D 1/00; B64C 1/00; G05D 3/00; G06F 7/00; G06F 17/00

(52) U.S. Cl. 701/4

(57) ABSTRACT

An attitude control system is disclosed for geostationary satellites including elongate members such as solar generators and/or antennas, in particular deployable members. The system includes gyroscopic actuators for supplying the torque necessary for maintaining the attitude of the satellite when subjected to disturbing forces or torques. The gyroscopic actuators preferably maintain a setpoint attitude during orbit correction phases.

### CROSS-REFERENCE TO RELATED APPLICATIONS

This application is based on French Patent Application No. 02 13 052 filed Oct. 21, 2002, the disclosure of which is hereby incorporated by reference thereto in its entirety, and the priority of which is hereby claimed under 35 U.S.C. §119.

### BACKGROUND OF THE INVENTION

1. Field of the Invention

The invention relates to a system for controlling the attitude of a geostationary satellite.

2. Description of the Prior Art

The attitude of satellites must be controlled continuously, in particular so that the antennas always retain a particular direction, generally pointing toward the Earth.

Thus sensors are provided in a satellite to detect the attitude of the satellite. The output signal of the sensors is compared to a set point attitude to provide a signal for controlling actuators for correcting the attitude of the satellite so that it corresponds to the set point.

The actuators are usually reaction wheels. A reaction wheel is a flywheel of high inertia that turns at high speed, for example at a speed of the order of 3000 revolutions per minute. When the flywheel is accelerated, i.e. when its rotation speed is increased, a reaction torque is exerted on the body of the satellite. To provide control in any direction, it is necessary to provide three wheels turning about axes forming a free base, for example, axes constituting an orthonomic system of axes.

The invention results from the observation that, from a certain size, the attitude of geostationary satellites with appendages of high inertia becomes difficult to control with reaction wheels.

A structure with large dimensions attached to the body of the satellite in a manner that is necessarily flexible will interfere with the attitude of the satellite.

The body of the satellite is subjected to disturbing torques or forces, such as those caused by activation of thrusters, which are transmitted to the appendage and cause movements at low frequencies. This applies to solar generators, which oscillate freely with small amplitudes. If the natural frequencies of the appendages are particularly low, then their oscillations must be controlled. Reaction wheels cannot oppose these high torques, all the more so in that it is also necessary to oppose sloshing of the fuel of the propulsion system. It has been proposed to combine reaction wheels with thrusters of a chemical propulsion system to control the attitude of this type of satellite. However, using thrusters creates disturbances to the orbit and the accuracy of pointing obtained is insufficient.

The invention solves this problem. To this end, the attitude control system according to the invention for a geostationary satellite is characterized in that it includes a set of gyroscopic actuators.

Gyroscopic actuators are generally proposed for attitude correction of satellites in low Earth orbit, as they generate a high torque in a short time, the missions of such satellites making it necessary to be able to effect fast changes of pointing.

A gyroscopic actuator also includes a flywheel turning at constant speed, but it is the variation in the direction of the rotation axis of the flywheel that applies a torque to the satellite.

A plurality of gyroscopic actuators are provided to be able to create a torque in any given direction. To this end, four gyroscopic actuators can be used fitted with single-axis gimbals disposed in a pyramid-shaped configuration, as described in French patent 2 796 172.

Gyroscopic actuators can be used to maintain accurate pointing of the satellite toward the Earth during East/West and/or North/South orbit correction phases and also for other phases such as the apogee burn phase during injection into orbit. They also improve the control of sloshing of fuels such as ergols.

In one embodiment of the attitude control system using gyroscopic actuators, the regulation loop uses a corrector whose structure and settings are based on the definition of a bandwidth of the regulation loop that contains the lowest and most energetic frequencies of the flexible modes of the appendages. Thus this corrector can stabilize the system by having the gyroscopic actuators oppose the oscillatory torques of solar generator panels or antennas.

### SUMMARY OF THE INVENTION

Accordingly, the invention provides an attitude control system for a geostationary satellite including elongate members such as solar generators and/or antennas, in particular deployable members, which system includes gyroscopic actuators for supplying the torque necessary for maintaining the attitude of the satellite when subjected to disturbing forces or torques.

In one embodiment the gyroscopic actuators are adapted to maintain a setpoint attitude during orbit correction phases, and are preferably adapted to control the attitude during the phase of insertion into a geostationary orbit.

In one preferred embodiment the system further includes an attitude regulation loop including a corrector such that the bandwidth of the loop contains the lowest and most energetic frequencies of the flexible modes of the elongates. The loop can include a corrector of the proportional, integral, derivative type associated with an attenuation filter or a corrector synthesized by means of advanced system control methods such as the H∞ and Linear Matrix Inequality methods.

One method is described in the following documents, for example:

J. C. Doyle, K. Glover, P. K. Khargonekar, B. A. Francis, “State-space solutions to standard H2 and Hinfinity control problems”, IEEE Trans. Autom. Control, AC34, N° 8, p. 831-846, 1989, and

P. Gahinet, P. Apkarian, “A Linear Matrix Inequality approach to Hinfinity control”, Int. Journal of Robust and Nonlinear Control, Vol. 4, p. 421-448, 1994.

An LMI method is described in the following documents, for example:

S. Boyd, L. El Ghaoui, E. Feron, V. Balakrishnan, “Linear Matrix Inequalities in System and Control Theory”, Studies in Appl. Math. SIAM, Vol. 15, 1994, and

S. Boyd, L. El Ghaoui, E. Feron, V. Balakrishnan, “Control System Analysis and Synthesis via LMIs”, American Control Conference, p. 2147-2154, 1993.

Other features and advantages of the invention will become apparent in the light of the following description with reference to the appended drawings of embodiments of the invention.

### BRIEF DESCRIPTION OF THE DRAWINGS

FIG. 1 is a schematic of a satellite to which the invention applies.

FIG. 2 is a schematic of a prior art gyroscopic actuator.

FIG. 3 is a schematic of an attitude control system according to the invention.

FIGS. 4a, 4b and 5 are diagrams showing one example of the operation of the device according to the invention.

### DETAILED DESCRIPTION OF THE PREFERRED EMBODIMENT

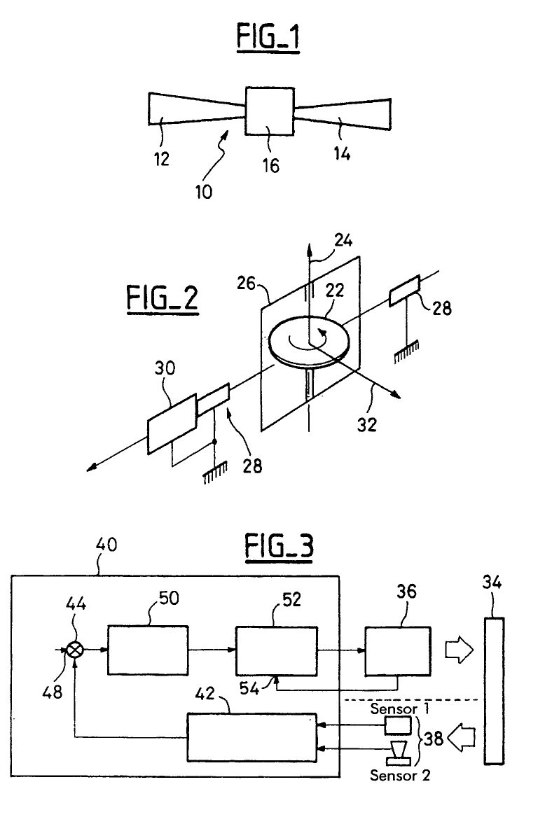

FIG. 1 shows a geostationary satellite 10 equipped with solar generators 12 and 14 for supplying it with electrical energy, the dimensions of which are large relative to that of its body 16. When a disturbing torque is exerted on the body 16 of the satellite, the lightweight panels oscillate at a low frequency, the amplitude of oscillation being relatively low. These types of deformation are called flexible modes.

The same problem of oscillation arises when the satellite is provided with antennas or any other structure with large dimensions, generally deployable.

To oppose oscillations of the above type, the invention proposes to control the attitude of the satellite using a set of gyroscopic actuators providing fast exchange of the kinetic moment of the set with the kinetic moment of the satellite.

FIG. 2 shows a gyroscopic actuator. It comprises a wheel 22 turning at constant speed about an axis 24. Its suspension and drive mechanism 26 is mounted on a gimbal cradle 28 and an electric motor 30 tilts the mechanism 26 to modify the orientation of the rotation axis 24.

The output torque 32 is the vector product of the rate of tilting of the gimbal and the kinetic moment of the flywheel. This torque is perpendicular to the rotation axis of the gimbal and to the axis of the wheel. It therefore turns relative to the satellite. To exert the required torque on the satellite, at least three gyroscopic actuators, capable of delivering several tens of Newton-meters, are provided.

FIG. 3 shows schematically the attitude control system of the satellite. In this figure, the whole of the satellite, with its body 16 and its panels 12 and 14, is represented by an elongate rectangle 34, and the set of gyroscopic actuators is represented by a block 36. Sensors 38 detect the attitude of the satellite. This is known in the art. The signals provided by the sensors 38 are delivered to a control and regulation loop 40, generally taking the form of software for a computer processor. The loop 40 also receives signals from the set of gyroscopic actuators 36 and supplies control signals to the actuators.

The loop 40 includes a unit 42 for processing signals supplied by the sensors 38 to format them so that they represent the attitude of the satellite, and the signal supplied by the unit 42 is delivered to the input of a subtractor 44 which subtracts the measured attitude signals from a setpoint signal applied to another input 48 of the subtractor 44. The output signal of the subtractor 44, which represents the error signal, is applied to the input of a corrector unit 50 which prevents instability of the regulation loop and accounts for pointing performance. As a general rule, the corrector unit is such that the bandwidth of the regulation loop contains the lowest and most energetic frequencies of the flexible modes.

The corrector unit 50 can include a PID (Proportional, Integral, Derivative) corrector and filters, for example, or any other corrector based on advanced system control methods, such as the H∞ and LMI (Linear Matrix Inequality) methods.

The output signal of the unit 50 is applied to the set 36 of gyroscopic actuators via an interface unit 52 also receiving at an input 54 a measurement signal giving the angular position of each of the gyroscopic actuator gimbals.

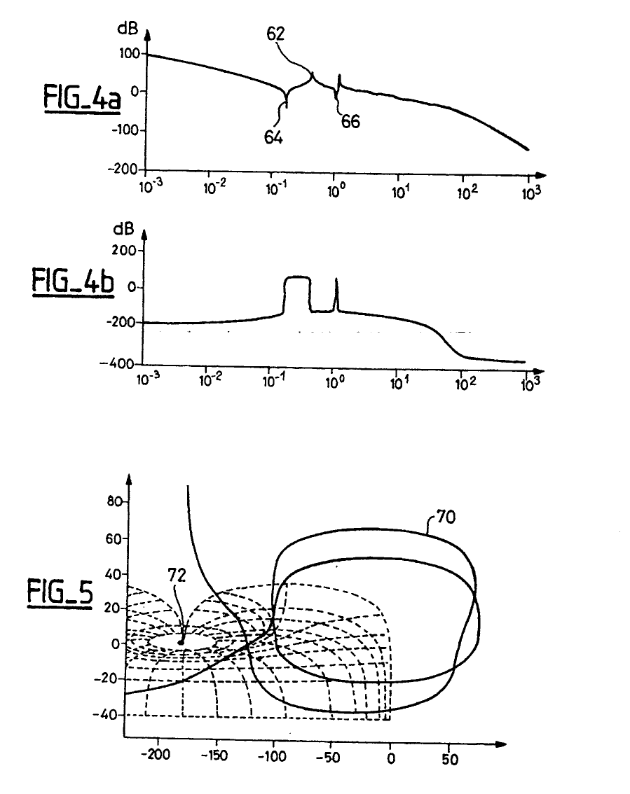

FIGS. 4a and 4b are examples of Bode diagrams for the regulation system.

In FIG. 4a the angular frequency in radians per section is plotted on the abscissa axis and the gain in decibels is plotted on the ordinate axis. In FIG. 4b the angular frequency in radians per second is plotted on the abscissa axis and the phase in degrees is plotted on the ordinate axis.

A resonant peak 62 and anti-resonant peaks 64, 66 that correspond to the flexible mode can be seen in FIG. 4a.

The FIG. 5 diagram is a Black or Nichols diagram in which the phase in degrees is plotted on the abscissa axis and the open loop gain in decibels is plotted on the ordinate axis. The curve 70 corresponds to various values of the parameter c and the portions to the right of the critical point 72 (gain 0 dB, phase 0°) correspond to the flexible mode.

The control system according to the invention provides very accurate guidance and therefore improved pointing performance.

There is claimed:

1. An attitude control system for a geostationary satellite including elongate members such as solar generators and/or antennas, in particular deployable members, which system includes gyroscopic actuators for supplying the torque necessary for maintaining the attitude of said satellite when subjected to disturbing forces or torques.

2. The system claimed in claim 1 wherein said gyroscopic actuators are adapted to maintain a setpoint attitude during orbit correction phases.

3. The system claimed in claim 2 wherein said gyroscopic actuators are adapted to control the attitude during a phase of insertion into a geostationary orbit.

4. The system claimed in claim 1, further including an attitude regulation loop including a corrector such that the bandwidth of said loop contains the lowest and most energetic frequencies of the flexible modes of said elongate members.

5. The system claimed in claim 4 wherein said corrector of said loop is of the proportional, integral, derivative type and is associated with an attenuation filter.

6. The system claimed in claim 4 wherein said corrector of said loop is synthesized by means of advanced system control methods such as the H∞ and Linear Matrix Inequality methods.
